(19) United States
(12) Patent Application Publication
(10) Pub. No.: US 2017/0227362 A1
(43) Pub. Date: Aug. 10, 2017

(54) MARINE VESSEL NAVIGATION DEVICE

(71) Applicant: Furuno Electric Co., Ltd., Nishinomiya (JP)

(72) Inventors: Iker Pryszo, Beaverton, OR (US); Brice Pryszo, Bidart (FR)

(21) Appl. No.: 15/017,528

(22) Filed: Feb. 5, 2016

(51) Int. Cl. G01C 21/20; B63B 49/00

(52) U.S. Cl. CPC G01C 21/203; B63B 49/00

(57) ABSTRACT

Disclosed is a navigation device comprising a processor, memory, and a display. The processor may store a map, minimum and maximum cross track error values, and safety conditions in the memory. The processor may receive a user-inputted route and control display of the route on the map such that if the route is within the safety conditions at a maximum width, the route is displayed in a first display mode. If at least a portion of the route at the maximum width is not within the safety conditions, the route width is reduced, and if the route is within the safety conditions at the reduced width, the route is displayed in the first display mode at the reduced width, but if the route is not within the safety conditions at a minimum width, the route is displayed in a second display mode at the minimum width.

### BACKGROUND

Navigation of a marine vessel is typically aided by a navigation system which displays a map. If a user is able to customize a route on the map during the planning stages, the marine vessel may be inadvertently directed through unsafe channels. Shallow water, land, large debris, bridges, cables, and others present obstacles that can hinder a marine vessel on a voyage. Conventional navigation systems check the safety of a route using a fixed distance, which is not practical for the user, especially in tight passages. Sometimes, this results in the user manually reducing the distance or disabling the safety check of the route entirely in order to not be bothered by the overly restrictive cross track error. Even when the user leaves the cross track error intact, the fixed cross track error distance is not able to take into account the wide distance needed in open water and the maximum safe distance through tight passages.

### SUMMARY

To address the above issues, devices and methods for automatic route adjustment are disclosed herein. According to one aspect, a navigation device may comprise a processor, memory, and a display, and the processor may be configured to store a map, minimum and maximum cross track error values, and safety conditions of an area of the map in the memory. The processor may be configured to receive a user-inputted route through the area and control display of the route on the map on the display such that if the route is within the safety conditions at a route width at the maximum cross track error value, the route is displayed in a first display mode at the route width, and if at least a portion of the route at the route width at the maximum cross track error value is not within the safety conditions, the route width is reduced to a reduced route width at a cross track error value between the maximum cross track error value and the minimum cross track error value. Then, if the route is within the safety conditions at the reduced route width, the route is displayed in the first display mode at the reduced route width, and if the route is not within the safety conditions at the reduced width at the minimum cross track error value, the route is displayed in a second display mode at the reduced route width, the second display mode visually different from the first display mode.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a simplified schematic view of a navigation device.

FIG. 2 is an illustrative example of a route safety configuration screen for a navigation program executed by the navigation device.

FIGS. 3A and 3B illustrate an example of a normal route setting operation when using the navigation program.

FIGS. 4A and 4B illustrate an example of an automatically adjusted route setting operation when using the navigation program.

FIGS. 5A and 5B illustrate an example of an unsafe route setting operation when using the navigation program.

FIG. 6 is a flowchart of a method for route setting by the navigation device.

FIG. 7 is a detailed flowchart of a step of the method of FIG. 6.

FIG. 8 is a simplified schematic view of an example computing system.

FIG. 9 is an illustration of the navigation device installed in a marine vessel.

FIGS. 10A and 10B illustrate examples of a conventional route setting operation.

### DETAILED DESCRIPTION

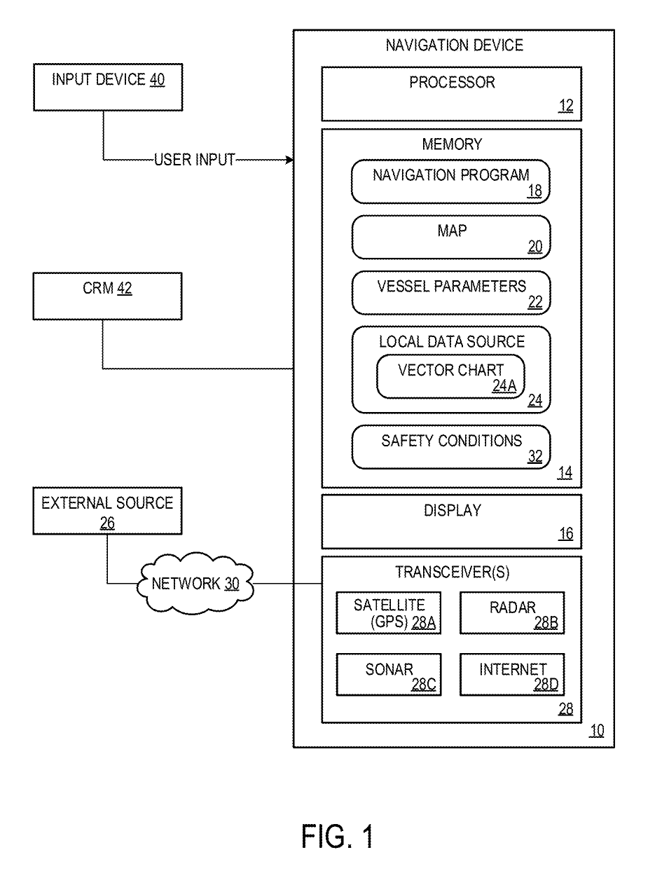

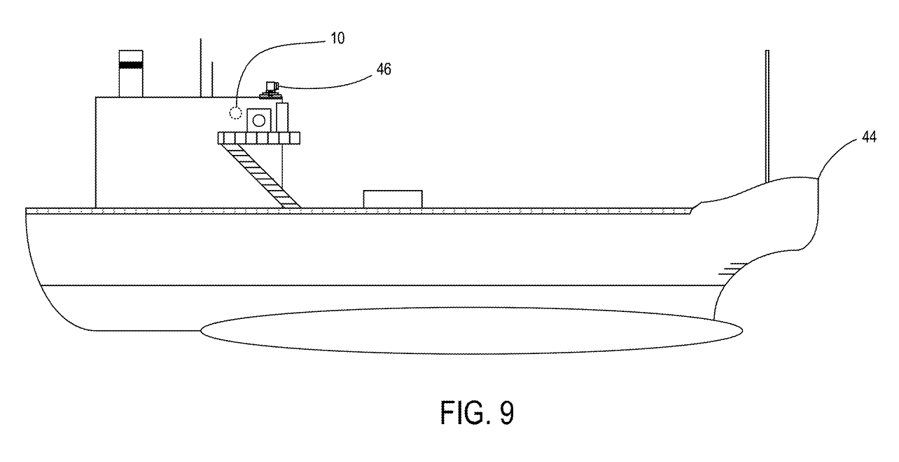

FIG. 1 is a simplified schematic view of a navigation device 10, which may be a marine vessel navigation device incorporated in a navigation suite installed in a marine vessel 44 (see FIG. 9). The navigation device may comprise a processor 12, memory 14, and a display 16. It will be appreciated that the display 16 may be built in or external to the navigation device 10.

The processor 12 may be configured to execute a navigation program 18 stored in the memory 14. The processor 12 may be configured to store a map 20 in the memory 14. In some configurations, the map 20 may be streamed from an external source 26 and stored temporarily in the memory 14. The processor 12 may be configured to store vessel parameters 22 including a minimum cross track error value and a maximum cross track error value in the memory 14. The cross track error may indicate how far to the left or right the marine vessel may veer off course and may account for a large turning radius, drift, mistakes, etc. The cross track error may be limited by the minimum and maximum cross track error values, and the minimum cross track error value and the maximum cross track error value may be parameters inputted by a user, or else read from preset settings associated with a particular type of marine vessel.

As shown in FIG. 1, the navigation device 10 may have access to one or more data source. The navigation device 10 may store a local data source 24 in the memory 14, or may receive transmissions from one or more external source 26 via a transceiver 28. In some cases, the external source may transmit to the transceiver 28 via a network 30 such as a wide-area network (WAN). In other cases, the external source 26 may transmit directly to the transceiver 28 or via satellites, for example, when radio signals are utilized for data transmission. The transceiver 28 may comprise multiple transceivers of varying types or separate receivers and transmitters. For example, the transceiver 28 may include a satellite transceiver 29A configured to communicate with a global positioning system (GPS) or other satellite systems, a radar transceiver 28B configured to send and receive radar information, a sonar transceiver 28C configured to send and receive sonar information, and an internet transceiver 28D configured to communication via the network 30. In some cases, the external source 26 may include one or more sensors 46 on the marine vessel 44 (see FIG. 9), configured to detect information such as a speed, a velocity, or an attitude of the ship. Furthermore, the sensors 46 may include a camera configured to stream delayed or live footage of an environment around the marine vessel 44 so that the map 20 may be displayed in a realistic manner. It will be appreciated that some of the information received by the transceiver 48 may be detected by other instruments, such as the sensors 46, in the navigation suite of the marine vessel 44 and then relayed to the navigation device 10.

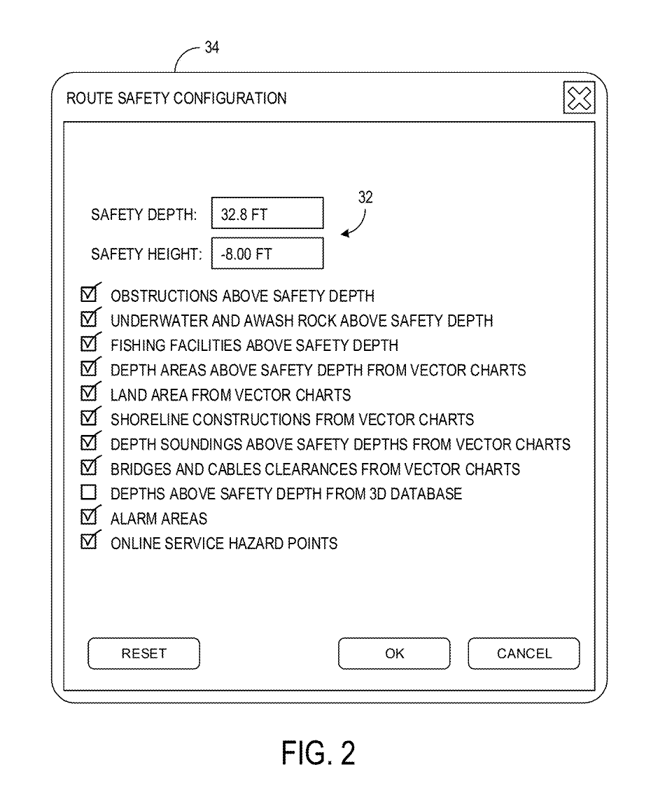

The processor 12 may be configured to store safety conditions 32 of an area of the map 20 in the memory 14. Some safety conditions 32 may apply to more than one area. In some cases, the safety conditions 32 may include or be compared to one or more of the vessel parameters 22. FIG. 2 is an illustrative example of a route safety configuration screen 34 for the navigation program 18 executed by the navigation device 10. In the configuration screen 34, the user may be able to customize the parameters of the navigation program 18. In one example, the safety conditions 32 include at least a water depth and a minimum depth clearance of the marine vessel. Incorporating such safety conditions 32 may help navigate the marine vessel through shallow water according to a safety depth, which is usually at least the minimum depth clearance. In another example, the safety conditions 32 further include an obstruction clearance height and a vessel height. For instance, the obstruction clearance height may be of a bridge or cables hanging over water, and the vessel height or safety height may be compared to the obstruction clearance height to judge if the marine vessel may pass safely underneath the obstruction. Other safety conditions may include underwater obstruction depth, awash rock depth, fishing facilities depth, presence of land, alarm areas, and hazard points, to provide merely a few examples.

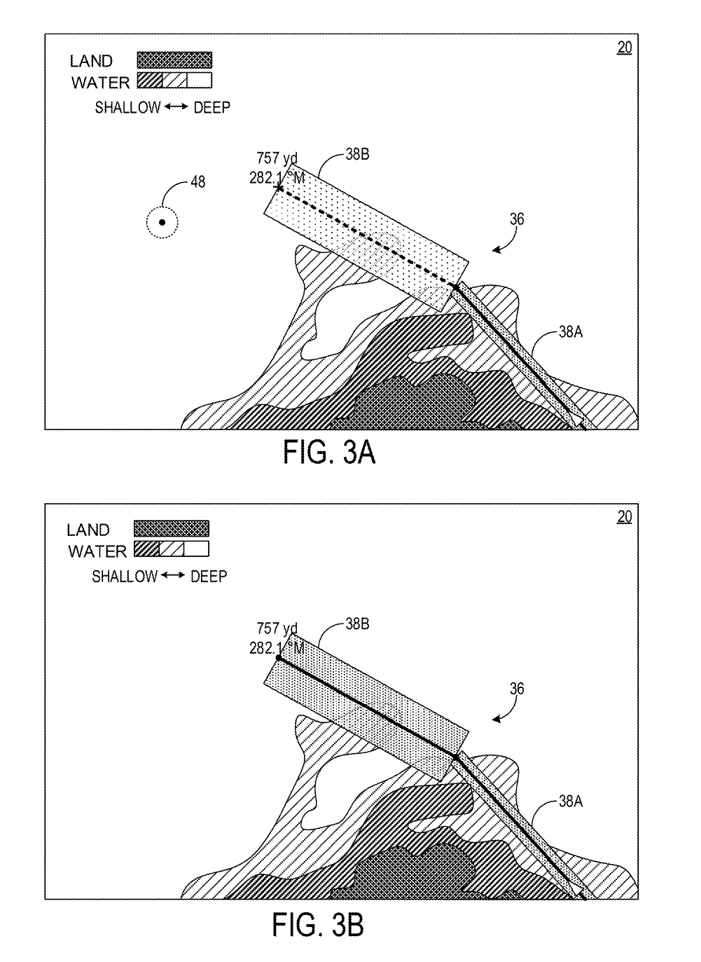

Furthermore, at least one data source of the safety conditions 32 may be selectable. In the example shown in FIG. 2, the checkmarks show safety conditions 32 of data sources that have been selected. Alternatively, the navigation program 18 may allow data sources to be selected first, and then individual safety conditions 32 of the selected data sources may be chosen. As discussed above, the data sources may be the local data source 24 or the external source 26. For example, the data source may comprise at least one of a vector chart 24A, a raster chart, user-input information, and an external database. Examples of the user-input information include the safety conditions 32 such as the minimum depth clearance or a safety depth, the vessel height or a safety height, a vessel width or a safety width, etc. In some examples, the navigation device 10 may be configured to receive virtual pins 48 (see FIG. 3A) on the map 20 as the user-input information in order to indicate an unsafe or otherwise undesirable location that the user wishes to avoid during route planning. Various vessel parameters 22 may be extrapolated based on manufacturer specifications of the marine vessel, or the user may input the vessel parameters 22, and may also include a buffer to allow for heightened safety. Examples of the external database, which is an external source 26, may include any chart or information that is stored externally. In one particular example, the external database may include information collected via an online service which provides up-to-date hazard information to users.

FIGS. 3A and 3B illustrate an example of a normal route setting operation when using the navigation program 18. FIG. 3A shows an area of a map 20 which indicates borders between land and water. In this example, different depths of water are represented in varying colors, transparencies, patterns, etc., but the map may also hide depth information in favor of decluttering the map 20. A legend in the top left corner of FIG. 3A identifies swatches of the various colors, transparencies, patterns, etc. used in the map 20.

The processor 12 may be configured to receive a user-inputted route 36 through the area. The route 36 comprises a segment 38A which has already been set and in FIG. 3A, the user is in the process of appending another segment 38B to the segment 38A to continue the route 36. When the segment 38B is inputted, its width is automatically a maximum route width that corresponds to the maximum cross track error value stored in the memory. The width of the route is generally twice the current cross track error value, since the cross track error applies to the left and to the right of the route 36. In this example, the segment 38B is partially transparent so that the land or water beneath the segment 38B is visible, thereby allowing the user to place the segment 38B with increased accuracy.

Using an input device 40, the user may finely customize the route 36. While the segments 38A, 38B are shown here as straight lines, they may be any suitable shape such as an arc or other curve. The route 36 may be inputted by dragging a cursor from a starting position to an ending position, and if the segment 38B is acceptable, the navigation program 18 may allow the user to set or finalize the segment 38B, for example, by releasing the cursor. A confirmation step may also be included before the route 36 is finalized. Other suitable input methods may also be considered.

As can be seen in FIG. 3A, the new segment 38B is a different pattern than the set segment 38A, which indicates a different color when shown on the display 16. When the segment 38B is set, as shown in FIG. 3B, the processor 12 may be configured to control display of the route 36 on the map 20 on the display 16 such that if the route 36 is within the safety conditions 32 at a route width at the maximum cross track error value, the route 36 is displayed in a first display mode at the route width. In this example, the first display mode may be a first color, for example, green, indicating that the full width of the route is within the safety conditions and therefor safe to traverse by the marine vessel. In other instances, the first display mode may be one or more of a first pattern, a first color, a first flashing pattern, a first animation pattern, a first sound, etc.

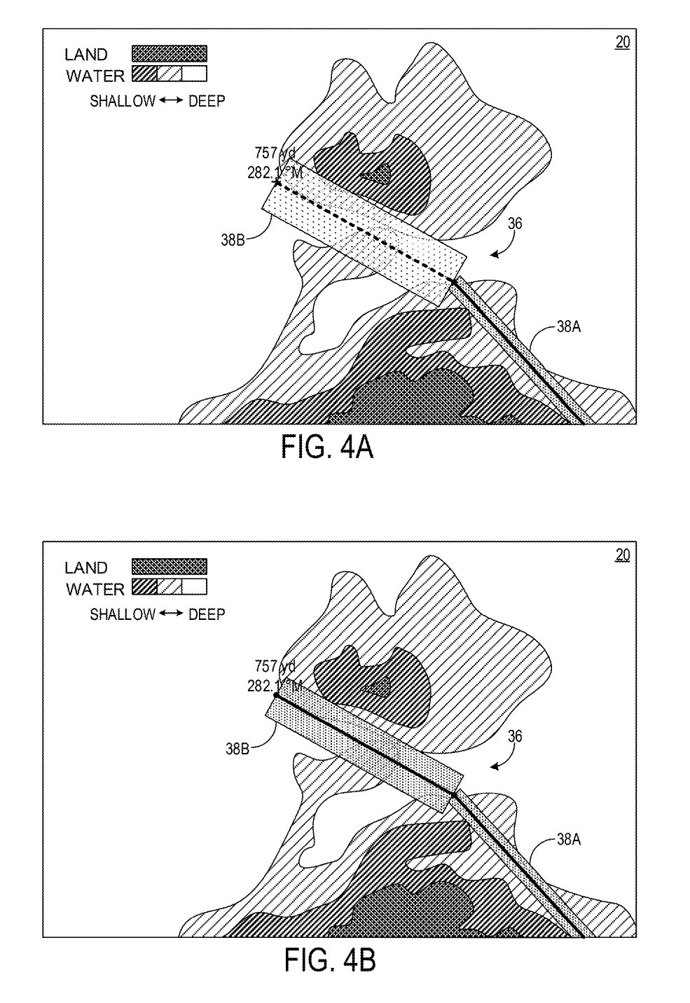

FIGS. 4A and 4B illustrate an example of an automatically adjusted route setting operation when using the navigation program 18. In FIG. 4A, the user has inputted the segment 38B as in FIG. 3A and the width of the segment 38B is automatically the maximum width; however, in this example, the water in a portion of the area of the segment 38B is very shallow. As shown in FIG. 4B, the processor 12 may be configured to control display of the route 36 on the map 20 on the display 16 such that if at least a portion of the route 36 at the route width at the maximum cross track error value is not within the safety conditions 32, the route width is reduced to a reduced route width at a cross track error value between the maximum cross track error value and the minimum cross track error value. This reduction is automatically performed as the user inputs the segment 38B so as to provide constant feedback regarding safety when planning the route 36.

Then, the processor 12 may be configured to control display of the route 36 on the map 20 on the display 16 such that if the route is within the safety conditions 32 at the reduced route width, the route 36 is displayed in the first display mode at the reduced route width. As can be seen in FIG. 4B, the segment 38B of the route 36 has been reduced in width so as to avoid the portion of the map 20 that is out of the safety conditions, in this example, the shallow water, so that the reduced segment 38B is entirely within the safety conditions. Once set, the segment 38B is the same color as the segment 38A, indicating that both segments 38A, 38B are within the safety conditions.

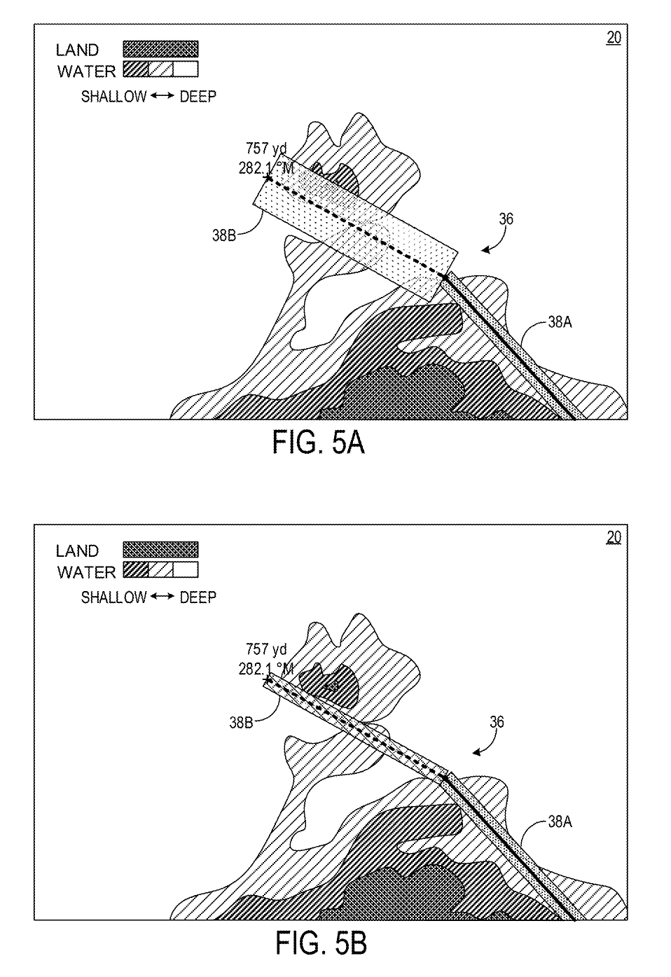

FIGS. 5A and 5B illustrate an example of an unsafe route setting operation when using the navigation program 18. FIG. 5A is the same as FIG. 4A, except that the terrain includes land and shallower water in the area where the segment 38B is being inputted. As before, the route width may be reduced to the reduced route width at a cross track error value between the maximum cross track error value and the minimum cross track error value. In this example, the route width is reduced down to a minimum route width, which is the reduced route width at the minimum cross track error value. As shown in FIG. 5B, the processor 12 may be configured to control display of the route 36 on the map 20 on the display 16 such that if the route 36 is not within the safety conditions 32 at the reduced width at the minimum cross track error value, the route 36 is displayed in a second display mode at the reduced route width, the second display mode visually different from the first display mode.

In the second display mode shown in FIG. 5B, a color of a cross track error area of the route 36 may be changed compared to the first display mode. In this example, the second display mode is a second color that is different from the first color, for example, red, but the second display mode may be one or more of a second pattern, a second color, a second flashing pattern, a second animation pattern, a second sound, etc. Additionally, to prevent unsafe route planning, when the route 36 is not within the safety conditions 32 at the reduced width at the minimum cross track error value, the navigation device may be further configured to block the user from setting the route 36. The user may then adjust the route 36 to a safe area in order to continue planning the route 36.

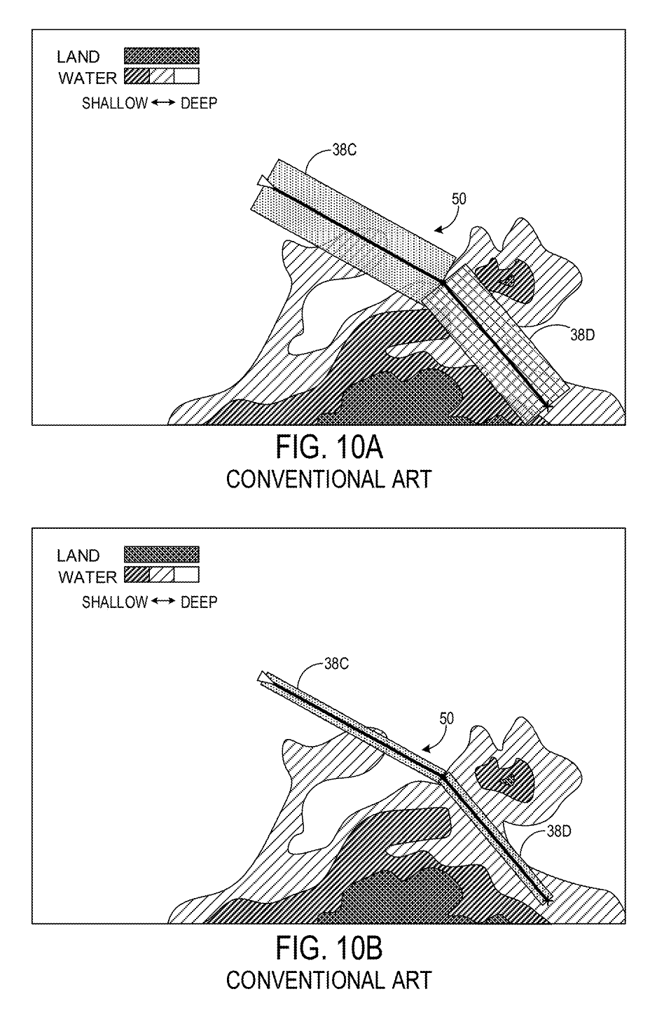

The automatic adjustment in the route setting operation discussed above with reference to FIGS. 3A-5B can easily be distinguished from conventional route setting operations, examples of which are illustrated in FIGS. 10A and 10B. Rather than the maximum and minimum cross track error values, the conventional operation makes use of a single, fixed cross track error value inputted by the user. In the example of FIG. 10A, the cross track error value is too large and a route 50 is not within the safety conditions during route segment 38D. While this large cross track error value informs the user of that it is safe to go off course during route segment 38C in open water, for example, to maneuver around another vessel or turn gradually with a large turning radius, the user does not have any information about what cross track error value, if any, would result in a safe route width during route segment 38D.

In response, as shown in FIG. 10B, the user has manually reduced the cross track error value and reattempted to draw the route 50. Because all route segments use the fixed, estimated cross track error value set by user, and because the user makes a rough estimate of a safe distance between two land masses, the route segments 38C and 38D are unnecessarily narrowed by the user to the same route width. In this case, the user does not know whether or not a greater route width for segment 38C would be safe, in the eventuality that the marine vessel needs to maneuver around a new obstacle, for instance. In contrast, the navigation device 10 with the navigation program 18 performs automatic adjustment of the cross track error during route planning so that the user can plan each route segment with the greatest cross track error value, up to the maximum, that is determined to be safe in view of the safety conditions. In this manner, the planned route is highly specified by the user and each segment thereof is automatically checked for safety and reduced to a safe width, in real-time.

As shown in FIG. 1, computer-readable media 42 may be configured to store a navigation program 18 in a non-transitory manner, which upon execution by a processor 12 of a navigation device 10 causes the navigation device 10 to store a map 20 in memory 14, store a minimum cross track error value and a maximum cross track error value in the memory 14, store safety conditions 32 of an area of the map 20 in the memory 14, and receive a user-inputted route through the area. The navigation program 18 may further cause the navigation device 10 to control display of the route on the map 20 on a display 16 such that if the route is within the safety conditions 32 at a route width at the maximum cross track error value, the route is displayed in a first display mode at the route width, and if at least a portion of the route at the route width at the maximum cross track error value is not within the safety conditions 32, the route width is reduced to a reduced route width at a cross track error value between the maximum cross track error value and the minimum cross track error value. Further, if the route is within the safety conditions 32 at the reduced route width, the route is displayed in the first display mode at the reduced route width, and if the route is not within the safety conditions 32 at the reduced width at the minimum cross track error value, the route is displayed in a second display mode at the reduced route width, the second display mode visually different from the first display mode. In some cases, when the route is not within the safety conditions 32 at the reduced width at the minimum cross track error value, the program 18 may be further configured to cause the navigation device 10 to block the user from setting the route.

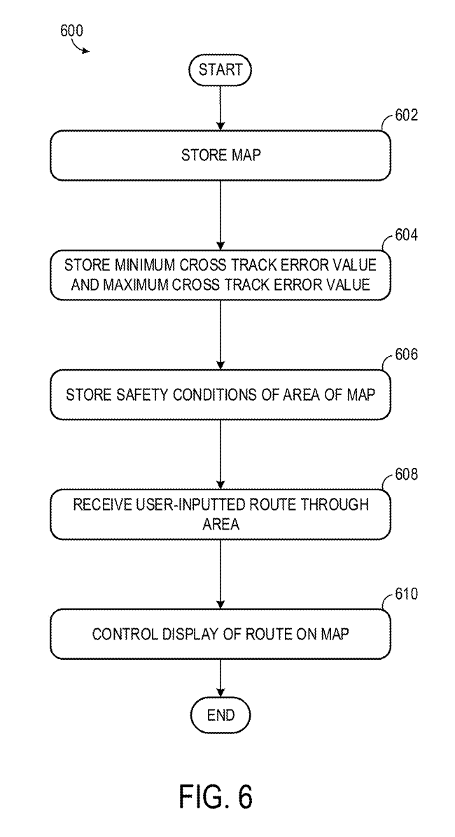

FIG. 6 is a flowchart of a method 600 for route setting by a navigation device. The following description of method 600 is provided with reference to the software and hardware components of the navigation device 10 described above and shown in FIGS. 1-2. The navigation device may be installed in a marine vessel. It will be appreciated that method 600 may also be performed in other contexts using other suitable hardware and software components.

With reference to FIG. 6, at 602 the method 600 may include storing a map. At 604 the method 600 may include storing a minimum cross track error value and a maximum cross track error value. The minimum cross track error value and the maximum cross track error value may be parameters inputted by a user. At 606 the method 600 may include storing safety conditions of an area of the map. The safety conditions may include at least a water depth and a minimum depth clearance of the marine vessel, and may further include an obstruction clearance height and a vessel height, among others. In one example, at least one data source of the safety conditions may be selectable. Such data sources may include a vector chart, a raster chart, user-input information, and an external database, for example. Finally, at 608 the method 600 may include receiving a user-inputted route through the area, and at 610 the method 600 may include controlling display of the route on the map.

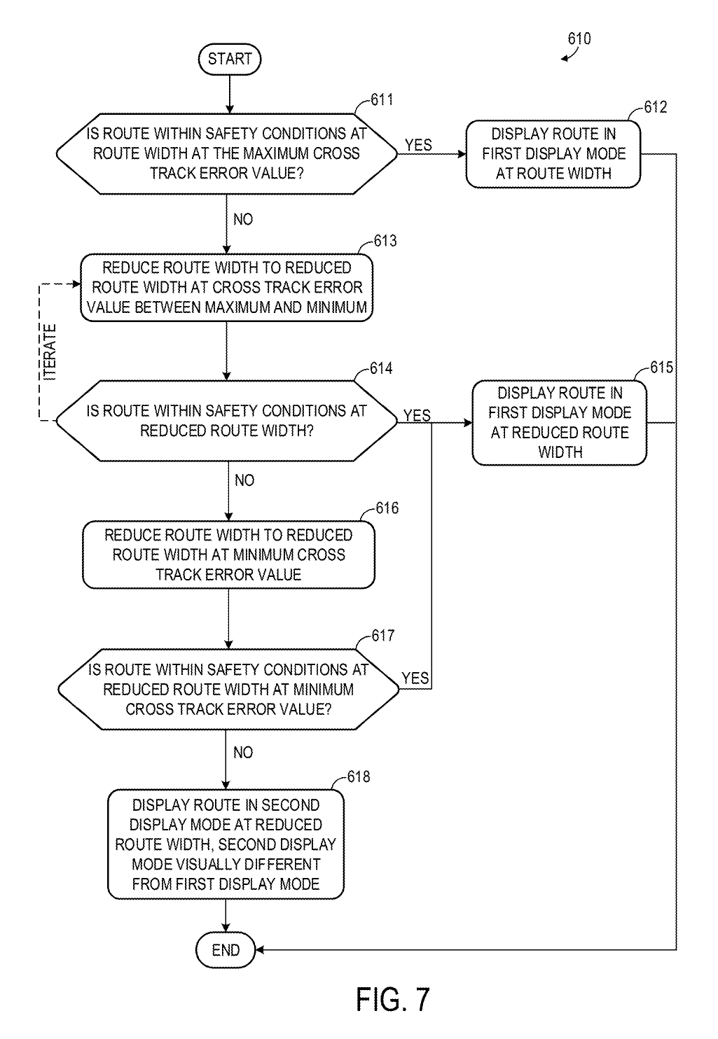

FIG. 7 is a detailed flowchart of the step 610 of the method 600 of FIG. 6. With reference to FIG. 7, at 611 controlling display of the route on the map may include determining if the route is within the safety conditions at a route width at the maximum cross track error value. This determination may include comparing values of the safety conditions that are applicable within the area of the currently pending segment of the route, at the current route width. Applicable safety conditions may be determined by including only data sources or safety conditions that are checked by the user in a route safety configuration screen and by checking the included data sources for the presence of unsafe features within the route area. For example, if the safety depth or minimum depth clearance of the vessel is 32.8 ft and the user has “DEPTH AREAS ABOVE SAFETY DEPTH FROM VECTOR CHARTS” checked as in FIG. 2, and the user attempts to create a route through an area where a vector chart indicates that the water depth is only 30 ft, then the navigation device may compare the two depths and determine that the route is not within the safety conditions at the route width at the maximum cross track error value. Thus, if NO at 611, in which case at least a portion of the route at the route width at the maximum cross track error value is not within the safety conditions, then at 613, the route width may be reduced to a reduced route width at a cross track error value between the maximum cross track error value and the minimum cross track error value. If YES, then at 612, the route may be displayed in a first display mode at the route width.

Then, at 614 the step 610 may include determining if the route is within the safety conditions at the reduced route width. If YES, at 615 the route may be displayed in the first display mode at the reduced route width. Steps 613 and 614 in which the route width is reduced by a small amount, for example, less than 10% of the difference between the maximum cross track error value and the minimum cross track error value, and then the route is checked against the safety conditions at the reduced route width, may be repeated iteratively so that the reduced route width displayed at 615 is the least reduced width (i.e., the greatest width) at which the route is within the safety conditions. If NO, in which case there is no route width at a cross track error value between the minimum and maximum values that is within the safety conditions and thus the iteration cannot continue, at 616 the route width is further reduced to a reduced route width at the minimum cross track error value.

At 617 the step 610 may include determining if the route is within the safety conditions at the reduced width at the minimum cross track error value. If YES, then the step 610 proceeds to 615 and the route may be displayed in the first display mode at the reduced route width, where the reduced route width is at the minimum cross track error value. If NO, in which case the route is not within the safety conditions at the reduced width at the minimum cross track error value, then at 618, the route is displayed in a second display mode at the reduced route width, the second display mode visually different from the first display mode. In some cases, in the second display mode, a color of a cross track error area of the route is changed compared to the first display mode. Alternatively or in addition, when the route is not within the safety conditions at the reduced width at the minimum cross track error value, the method may include blocking the user from setting the route.

The above described devices and methods may be used to automatically adjust a user-inputted route according to safety conditions to provide real-time feedback. The devices and methods may include controlling display of the route between a first and second display mode depending on whether or not the route is within the safety conditions and automatically reducing the width of the route between a maximum and minimum based on cross track error values and the safety conditions. In this manner, each segment of a route may be given the largest width that is safe, up to a preset maximum, while still allowing the user a high degree of customization of the route.

In some embodiments, the methods and processes described herein may be tied to a computing system of one or more computing devices. In particular, such methods and processes may be implemented as a computer-application program or service, an application-programming interface (API), a library, and/or other computer-program product.

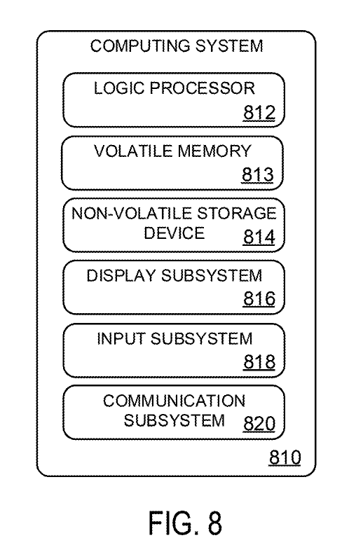

FIG. 8 schematically shows a non-limiting embodiment of a computing system 810 that can enact one or more of the methods and processes described above. Computing system 810 is shown in simplified form. Computing system 810 may embody one or more of the navigation device 10 and external source 26 of FIG. 1. Computing system 810 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 810 includes a logic processor 812, volatile memory 813, and a non-volatile storage device 814. Computing system 810 may optionally include a display subsystem 814, input subsystem 818, communication subsystem 820, and/or other components not shown in FIG. 8.

Logic processor 812 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor 812 may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 812 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 814 includes one or more physical devices configured to hold instructions executable by the logic processors to implement the methods and processes described herein. When such methods and processes are implemented, the state of non-volatile storage device 814 may be transformed—e.g., to hold different data.

Non-volatile storage device 814 may include physical devices that are removable and/or built-in. Non-volatile storage device 814 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 814 may include nonvolatile, dynamic, static, read/write, read-only, sequential-access, location-addressable, file-addressable, and/or content-addressable devices. It will be appreciated that non-volatile storage device 814 is configured to hold instructions even when power is cut to the non-volatile storage device 814.

Volatile memory 813 may include physical devices that include random access memory. Volatile memory 813 is typically utilized by logic processor 812 to temporarily store information during processing of software instructions. It will be appreciated that volatile memory 813 typically does not continue to store instructions when power is cut to the volatile memory 813.

Aspects of logic processor 812, volatile memory 813, and non-volatile storage device 814 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 810 typically implemented in software by a processor to perform a particular function using portions of volatile memory, which function involves transformative processing that specially configures the processor to perform the function. Thus, a module, program, or engine may be instantiated via logic processor 812 executing instructions held by non-volatile storage device 814, using portions of volatile memory 813. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 814 may be used to present a visual representation of data held by non-volatile storage device 814. The visual representation may take the form of a graphical user interface (GUI). As the herein described methods and processes change the data held by the non-volatile storage device, and thus transform the state of the non-volatile storage device, the state of display subsystem 814 may likewise be transformed to visually represent changes in the underlying data. Display subsystem 814 may include one or more display devices utilizing virtually any type of technology. Such display devices may be combined with logic processor 812, volatile memory 813, and/or non-volatile storage device 814 in a shared enclosure, or such display devices may be peripheral display devices.

When included, input subsystem 818 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 820 may be configured to communicatively couple various computing devices described herein with each other, and with other devices. Communication subsystem 820 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 810 to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A navigation device comprising:
a processor;
memory; and
a display;
wherein the processor is configured to:
store a map in the memory;
store a minimum cross track error value and a maximum cross track error value in the memory;
store safety conditions of an area of the map in the memory;
receive a user-inputted route through the area; and
control display of the route on the map on the display such that:
if the route is within the safety conditions at a route width at the maximum cross track error value, the route is displayed in a first display mode at the route width; and
if at least a portion of the route at the route width at the maximum cross track error value is not within the safety conditions, the route width is reduced to a reduced route width at a cross track error value between the maximum cross track error value and the minimum cross track error value, and:
if the route is within the safety conditions at the reduced route width, the route is displayed in the first display mode at the reduced route width; and
if the route is not within the safety conditions at the reduced width at the minimum cross track error value, the route is displayed in a second display mode at the reduced route width, the second display mode visually different from the first display mode.

2. The navigation device of claim 1, wherein the minimum cross track error value and the maximum cross track error value are parameters inputted by a user.

3. The navigation device of claim 1, wherein in the second display mode, a color of a cross track error area of the route is changed compared to the first display mode.

4. The navigation device of claim 1, installed in a marine vessel.

5. The navigation device of claim 4, wherein the safety conditions include at least a water depth and a minimum depth clearance of the marine vessel.

6. The navigation device of claim 5, wherein the safety conditions further include an obstruction clearance height and a vessel height.

7. The navigation device of claim 1, wherein at least one data source of the safety conditions is selectable.

8. The navigation device of claim 7, wherein the data source comprises at least one of a vector chart, user-input information, and an external database.

9. The navigation device of claim 1, wherein when the route is not within the safety conditions at the reduced width at the minimum cross track error value, the navigation device is further configured to block the user from setting the route.

10. A method for route setting by a navigation device, the method comprising:
storing a map;
storing a minimum cross track error value and a maximum cross track error value;
storing safety conditions of an area of the map;
receiving a user-inputted route through the area; and
controlling display of the route on the map such that:
if the route is within the safety conditions at a route width at the maximum cross track error value, the route is displayed in a first display mode at the route width; and
if at least a portion of the route at the route width at the maximum cross track error value is not within the safety conditions, the route width is reduced to a reduced route width at a cross track error value between the maximum cross track error value and the minimum cross track error value, and:
if the route is within the safety conditions at the reduced route width, the route is displayed in the first display mode at the reduced route width; and
if the route is not within the safety conditions at the reduced width at the minimum cross track error value, the route is displayed in a second display mode at the reduced route width, the second display mode visually different from the first display mode.

11. The method of claim 10, wherein the minimum cross track error value and the maximum cross track error value are parameters inputted by a user.

12. The method of claim 10, wherein in the second display mode, a color of a cross track error area of the route is changed compared to the first display mode.

13. The method of claim 10, wherein the navigation device is installed in a marine vessel.

14. The method of claim 13, wherein the safety conditions include at least a water depth and a minimum depth clearance of the marine vessel.

15. The method of claim 14, wherein the safety conditions further include an obstruction clearance height and a vessel height.

16. The method of claim 10, wherein at least one data source of the safety conditions is selectable.

17. The method of claim 16, wherein the data source comprises at least one of a vector chart, user-input information, and an external database.

18. The method of claim 10, wherein when the route is not within the safety conditions at the reduced width at the minimum cross track error value, the method further comprises blocking the user from setting the route.

19. Computer-readable media configured to store a navigation program in a non-transitory manner, which upon execution by a processor of a navigation device causes the navigation device to:
store a map in memory;
store a minimum cross track error value and a maximum cross track error value in the memory;
store safety conditions of an area of the map in the memory;
receive a user-inputted route through the area; and
control display of the route on the map on a display such that:
if the route is within the safety conditions at a route width at the maximum cross track error value, the route is displayed in a first display mode at the route width; and
if at least a portion of the route at the route width at the maximum cross track error value is not within the safety conditions, the route width is reduced to a reduced route width at a cross track error value between the maximum cross track error value and the minimum cross track error value, and:
if the route is within the safety conditions at the reduced route width, the route is displayed in the first display mode at the reduced route width; and
if the route is not within the safety conditions at the reduced width at the minimum cross track error value, the route is displayed in a second display mode at the reduced route width, the second display mode visually different from the first display mode.

20. The computer-readable media of claim 19, wherein when the route is not within the safety conditions at the reduced width at the minimum cross track error value, the program is further configured to cause the navigation device to block the user from setting the route.
